(19) United States
(12) Patent Application Publication
(10) Pub. No.: US 2026/0326693 A1
(43) Pub. Date: Oct. 22, 2026

(54) TRUNK BRANCH HIGH-VOLTAGE (HV) POWER DISTRIBUTION CABLE

(71) Applicant: International Truck Intellectual Property Company, LLC, Lisle, IL (US)

(72) Inventor: Michael James Miller, Mt. Prospect, IL (US)

(73) Assignee: International Truck Intellectual Property Company, LLC, Lisle, IL (US)

(21) Appl. No.: 19/181,988

(22) Filed: Apr. 17, 2025

(51) Int. Cl. B60R 16/033; H01B 9/04

(52) U.S. Cl. CPC B60R 16/033; H01B 9/04

(57) ABSTRACT

A trunk branch high-voltage power distribution system for a vehicle is provided. The system includes a trunk cable extending along a length of a high-voltage power distribution system in a vehicle; and a plurality of branch cables each of which extends along a width of the high-voltage power distribution system from the trunk cable to a corresponding one of a plurality of electrical components to be distributed electrical power or to supply the electrical power.

### FIELD OF THE DISCLOSURE

The present disclosure relates generally to vehicle high-voltage (HV) power distribution systems, and more particularly to a trunk branch HV power distribution cable.

### BACKGROUND

Existing HV power distribution architecture uses a “spider” structure in which a power distribution box is the central location (spider body) and splits off (spider legs) to various power storage and accessory components. Unfortunately, this type of system has many electrical connection points which are prone to lower electrically efficiency and increase the potential for loose connections. Standard HV power cables have a very limited bending radius which creates difficult packaging constraints for design engineers. This HV power distribution architecture is also extremely costly, with the power distribution box alone currently in the range of tens of thousands of US dollars. Therefore, a need exists for an improved HV power distribution architecture.

### SUMMARY OF THE INVENTION

In accordance with a first aspect, a trunk branch high-voltage power distribution system for a vehicle includes a trunk cable extending along a length of a high-voltage power distribution system in a vehicle; and a plurality of branch cables each of which extends along a width of the high-voltage power distribution system from the trunk cable to a corresponding one of a plurality of electrical components to be distributed electrical power or to supply the electrical power.

In an embodiment of the first aspect, each of the trunk and branch cables comprises a high-voltage conductor contained within an inner insulator and a shield between the inner insulator and an outer insulator, the trunk cable having an area that is larger than an area of any of the branch cables. In an embodiment of the first aspect, the high-voltage conductor, the shield, and the inner and outer insulators are coaxially arranged. In an embodiment of the first aspect, the high-voltage conductor of the trunk cable is continuous with the high-voltage conductor of each of the plurality of branch cables. In yet another embodiment of the first aspect, the outer insulator of the trunk cable is continuous with the outer insulator of each of the plurality of branch cables. In another embodiment of the first aspect, the trunk cable is fixedly orthogonal to each of the plurality of branch cables. In yet another embodiment of the first aspect, the trunk cable is continuous with each of the plurality of branch cables. In another embodiment of the first aspect, a motor inverter is connected to an end of the trunk cable. In another embodiment of the first aspect, a high-voltage battery is connected to an end of at least one of the plurality of branch cables to supply the electrical power. In another embodiment of the first aspect, each of the trunk and branch cables is configured to transmit high-voltage electrical power that is above 60 volts.

According to a second aspect of the present disclosure, a trunk branch high-voltage power distribution system for a vehicle includes a trunk cable extending along a length of a high-voltage power distribution system in a vehicle; and a plurality of branch cables each of which extends directly from the trunk cable to a corresponding one of a plurality of electrical components to be distributed electrical power or to supply the electrical power.

In an embodiment of the second aspect, each of the trunk and branch cables comprises a high-voltage conductor contained within an inner insulator and a shield between the inner insulator and an outer insulator, the trunk cable having an area that is larger than an area of any of the branch cables. In an embodiment of the second aspect, the high-voltage conductor, the shield, and the inner and outer insulators are coaxially arranged. In an embodiment of the second aspect, the high-voltage conductor of the trunk cable is continuous with the high-voltage conductor of each of the plurality of branch cables. In another embodiment of the second aspect, the outer insulator of the trunk cable is continuous with the outer insulator of each of the plurality of branch cables. In yet another embodiment of the second aspect, the trunk cable is fixedly orthogonal to each of the plurality of branch cables. In yet another embodiment of the second aspect, the trunk cable is continuous with each of the plurality of branch cables. In another embodiment of the second aspect, a motor inverter is connected to an end of the trunk cable. In another embodiment of the second aspect, a high-voltage battery is connected to an end of at least one of the plurality of branch cables to supply the electrical power. In yet another embodiment of the second aspect, each of the trunk and branch cables is configured to transmit high-voltage electrical power that is above 60 volts.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 illustrates a prior art HV power distribution architecture using a spider structure.

FIG. 2 illustrates a trunk branch HV power distribution architecture in accordance with a representative embodiment of the present disclosure.

FIG. 3 illustrates a trunk branch positive side cable in accordance with a representative embodiment of the present disclosure.

In the following detailed description, various embodiments are described with reference to the appended drawings. Those of ordinary skill in the art will appreciate that the drawings are illustrated for simplicity and clarity and therefore may not be drawn to scale and may not include well-known features, that the order of occurrence of actions or steps may be different than the order described or may be performed concurrently unless specified otherwise, and that the terms and expressions used herein have the meaning understood by those of ordinary skill in the art except where different meanings are attributed to them herein. Like reference numerals refer to like elements or components throughout. Like elements or components will therefore not necessarily be described in detail with respect to each figure.

### DETAILED DESCRIPTION

The present disclosure relates to a trunk branch HV distribution architecture which uses a novel and inventive cable designed to the packaging of the HV electrical components in the vehicle. The trunk is a central cable that runs the length of the HV system, and the branches are “T's” off to each of the HV electrical components within the HV system. Since the trunk branch cable is designed specifically to correspond to the HV components on the vehicle, bends in the cable can be part of the cable design, thereby allowing for much tighter packaging. Since the trunk to branch connections are integrated into the cable, there can be no additional connection points, thereby improving electrical efficiency and eliminating the potential for loose electrical connections. Additionally, costs are reduced due to less items in the system, i.e., no distribution box and less connection points.

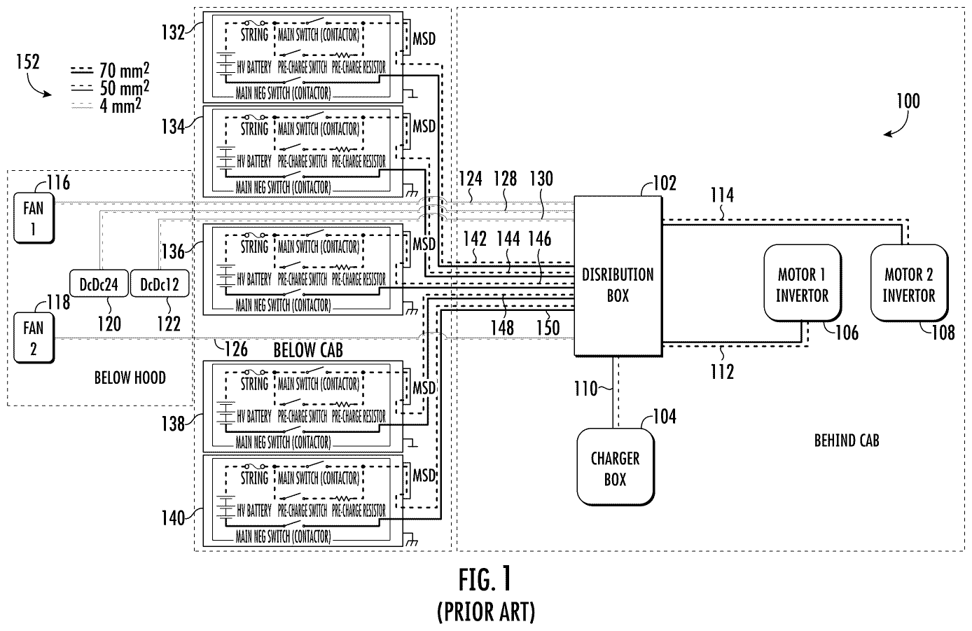

In FIG. 1, a prior art HV power distribution system 100 in a vehicle is shown. The system 100 uses a “spider” structure in which a distribution box 102 is the central location (spider body). The distribution box 102 includes multiple connection points to connect to various power storage/battery and electronic accessory components. A charger box 104, motor 1 invertor 106 and motor 2 invertor 108 are connected to the distribution box 102 via cables 110, 112 and 114, respectively. Fans 116 and 118 and DC-DC converters 120 and 122 are connected to the distribution box 102 via cables 124, 126, 128 and 130, respectively. HV batteries 132, 134, 136, 138 and 140 that supply power to the rest of the components are further connected to the distribution box 102 via cables 142, 144, 146, 148 and 150. All the cables 110, 112, 114, 124, 126, 128, 130, 142, 144, 146, 148 and 150 split off from the distribution box 102 and are routed to either power storage components, i.e., batteries, or electric accessory components that require power. This results in a complicated arrangements with many electrical connection points, which can lower electrical efficiency and increase the potential for loose connections.

Although FIG. 1 is shown with all the cables 110, 112, 114, 124, 126, 128, 130, 142, 144, 146, 148 and 150 as straight lines, in reality the cabling is restricted by the limitations of available space inside the vehicle, the actual length of the cables 110, 112, 114, 124, 126, 128, 130, 142, 144, 146, 148 and 150 between all the various connection points and the location of the various power storage and accessory components inside the vehicle. In reality, this spider architecture results in many bends, turns, twists, dips, and the like as the cables 110, 112, 114, 124, 126, 128, 130, 142, 144, 146, 148 and 150 are routed throughout the vehicle.

Each of the cables 110, 112, 114, 124, 126, 128, 130, 142, 144, 146, 148 and 150 is described herein as a single power line for clarity, but it should be understood that all or many of the cables 110, 112, 114, 124, 126, 128, 130, 142, 144, 146, 148 and 150 are further divided into positive and negative power lines. The cables 110, 112, 114, 124, 126, 128, 130, 142, 144, 146, 148 and 150 have different areas as shown in the key 152 in FIG. 1. Standard HV power cables have a very limited bending radius, particularly cables having larger areas such as the battery cables 142, 144, 146, 148, 150 (e.g., 70 mm²) and the motor invertor cables 112 and 114 (50 mm²). This creates challenging constraints for vehicle HV power distribution systems.

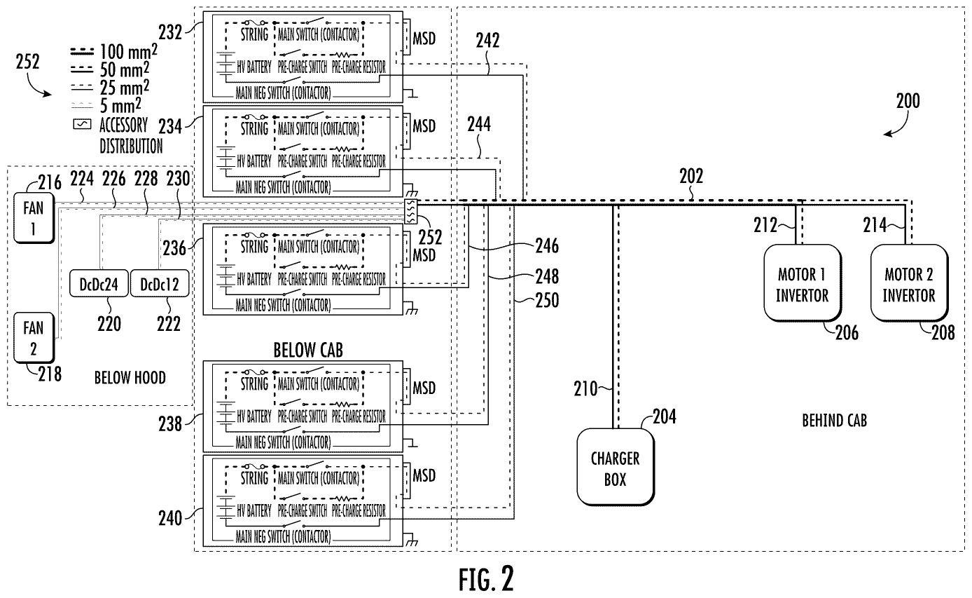

FIG. 2 illustrates a trunk branch HV power distribution system 200 in accordance with a representative embodiment of the present disclosure. The system 200 uses a trunk cable 202 that is a central cable that extends along a length of the system 200. Various branch cables branch off of the trunk cable 202 (similar to tree branches on a tree trunk) to each of the electrical components within the HV system. Instead of being routed through a distribution box, as in the prior art architecture depicted in FIG. 1, trunk-to-branch connections are integrated directly into the cable.

A charger box 204, motor 1 invertor 206 and motor 2 invertor 208 are connected to the trunk cable 202 via branch cables 210, 212 and 214, respectively. Fans 216 and 218 and DC-DC converters 220 and 222 are connected to the trunk cable 202 via branch cables 224, 226, 228 and 230, respectively. HV batteries 232, 234, 236, 238 and 240 that supply power to the rest of the components are further connected to the trunk cable 202 via trunk cables 242, 244, 246, 248 and 250. All the branch cables 210, 212, 214, 224, 226, 228, 230, 242, 244, 246, 248 and 250 branch off extending directly from the trunk cable 202 to a corresponding one of a plurality of electrical components to be distributed electrical power or to supply the electrical power.

Lengths of each of the branch cables 210, 212, 214, 224, 226, 228, 230, 242, 244, 246, 248 and 250 may correspond to the physical dimensions of the location inside the vehicle that they are designed for, such as a compartment behind the vehicle cabin or underneath the hood. The length of the trunk cable 202 may also correspond to the physical dimensions of the location inside the vehicle that it is designed for, such as behind the vehicle cabin. Thus, bends, twists, turns, dips, and the like which are required in prior art power distribution architectures can be minimized.

Each of the trunk and branch cables 202, 210, 212, 214, 224, 226, 228, 230, 242, 244, 246, 248 and 250 is described herein as a single power line for clarity, but it should be understood that all or many of the trunk and branch cables 202, 210, 212, 214, 224, 226, 228, 230, 242, 244, 246, 248 and 250 are further divided into positive and negative power lines.

The trunk and branch cables 202, 210, 212, 214, 224, 226, 228, 230, 242, 244, 246, 248 and 250 have different areas as shown in the key 252 in FIG. 2. The trunk cable 202 has a 100 mm² area. In other embodiments, trunk cables may have a larger or a smaller area. But the trunk cable should have an area that is larger than an area of any of the branch cables. This architecture allows for the charger box and motor invertor branch cables 210, 212 and 214 to have a 50 mm² area. The battery branch cables 242, 242, 246, 248 and 250 have a 25 mm² area, while the accessory components under the hood have branch cables 224, 226, 228 and 230 that have only a 5 mm² area.

The system 200 includes an accessory distribution box 252. The accessory distribution box 252 may include circuit breakers and fuses just for the lower-powered accessories, such as the fans 216, 218 and direct current (DC)-DC converters 220, 222. Because it handles lower-powered accessories, the cabling into and out of the accessory distribution box 252 can be much smaller than the HV cabling.

Still referring to FIG. 2, each of the trunk and branch cables 202, 210, 212, 214, 224, 226, 228, 230, 242, 244, 246, 248 and 250 have a conductor contained within an insulator. The conductor may be a plurality of conductive metal (e.g., copper or aluminum) wires bundled together into a high-voltage (HV) conductor core and surrounded by an inner insulator, and further surrounded by another protective layer, which may be a shield. The shield may be interposed between the inner insulator and an outer insulator. HV conductor, shield, and inner and outer insulators may be coaxially arranged. Multi-layer insulation prevents HV electrical current from escaping from the inner conductive core into the outside environment.

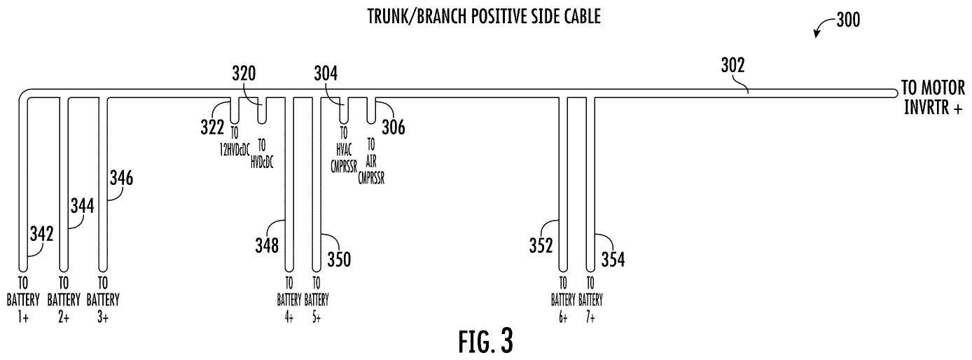

FIG. 3 illustrates a trunk branch cable 300 in accordance with a representative embodiment of the present disclosure. For clarity, FIG. 3 illustrates only the positive side of the trunk branch cable 300, but it should be understood that a negative/ground side of the trunk branch cable 300 should also be present and therefore the description also applies to a corresponding negative/ground side trunk branch cable (not shown).

The trunk branch cable 300 includes a trunk cable 302 and a plurality of branch cables 304, 306, 320, 322, 342, 344, 346, 348, 350, 352 and 354 each of which extends directly from the trunk cable 302, without passing through a power distribution box. An end of the trunk cable 302 connects to a motor invertor. A high-voltage battery is connected to an end of each of a first set of a plurality of branch cables 342, 344, 346, 348, 350, 352 and 354 to supply electrical power to other components connected to the trunk cable 302. HV DC-DC converters and HV compressors are connected at ends of each of a second set of a plurality of branch cables 304, 306, 320 and 322 to be supplied the electrical power. These components are examples. In other embodiments, alternative and/or additional electrical components can be connected at ends of the branch cables. Each of the trunk and branch cables 302, 304, 306, 320, 322, 342, 344, 346, 348, 350, 352 and 354 are configured to transmit HV electrical power that is at least above 60 volts, or higher.

As seen in FIG. 3, trunk cable 302 is continuous with each of the plurality of branch cables 304, 306, 320, 322, 342, 344, 346, 348, 350, 352 and 354. HV conductor of the trunk cable 302 is continuous with HV conductor of each of the plurality of branch cables 304, 306, 320, 322, 342, 344, 346, 348, 350, 352 and 354. Outer insulator of trunk cable 302 is continuous with outer insulator of each of the plurality of branch cables 304, 306, 320, 322, 342, 344, 346, 348, 350, 352 and 354. Trunk cable 302 is fixedly orthogonal to each of the plurality of branch cables 304, 306, 320, 322, 342, 344, 346, 348, 350, 352 and 354, each trunk-branch node being T-shaped.

In alternative embodiments, each trunk-branch node is connected by a T-connector; instead of conductor and insulator layers being continuous along the trunk and branch cables 302, 304, 306, 320, 322, 342, 344, 346, 348, 350, 352 and 354.

While the disclosure and what is presently considered to be the best mode thereof has been described in a manner establishing possession and enabling those of ordinary skill in the art to make and use the same, it will be understood and appreciated that there are many equivalents to the select embodiments described herein and that myriad modifications and variations may be made thereto without departing from the scope and spirit of the disclosure, which is to be limited not by the embodiments described herein but by the appended claims and their equivalents. For example, various components of the embodiments may be interchanged, added, or substituted in the other embodiments.

What is claimed is:

1. A trunk branch high-voltage power distribution system for a vehicle comprising:
a trunk cable extending along a length of a high-voltage power distribution system in a vehicle; and
a plurality of branch cables each of which extends along a width of the high-voltage power distribution system from the trunk cable to a corresponding one of a plurality of electrical components to be distributed electrical power or to supply the electrical power.

2. The system of claim 1, wherein each of the trunk and branch cables comprises a high-voltage conductor contained within an inner insulator and a shield between the inner insulator and an outer insulator, the trunk cable having an area that is larger than an area of any of the branch cables.

3. The system of claim 2, wherein the high-voltage conductor, the shield and the inner and outer insulators are coaxially arranged.

4. The system of claim 3, wherein the high-voltage conductor of the trunk cable is continuous with the high-voltage conductor of each of the plurality of branch cables.

5. The system of claim 3, wherein the outer insulator of the trunk cable is continuous with the outer insulator of each of the plurality of branch cables.

6. The system of claim 1, wherein the trunk cable is fixedly orthogonal to each of the plurality of branch cables.

7. The system of claim 6, wherein the trunk cable is continuous with each of the plurality of branch cables.

8. The system of claim 6, wherein a motor inverter is connected to an end of the trunk cable.

9. The system of claim 8, wherein a high-voltage battery is connected to an end of at least one of the plurality of branch cables to supply the electrical power.

10. The system of claim 1, wherein each of the trunk and branch cables is configured to transmit high-voltage electrical power that is above 60 volts.

11. A trunk branch high-voltage power distribution system for a vehicle comprising:
a trunk cable extending along a length of a high-voltage power distribution system in a vehicle; and
a plurality of branch cables each of which extends directly from the trunk cable to a corresponding one of a plurality of electrical components to be distributed electrical power or to supply the electrical power.

12. The system of claim 11, wherein each of the trunk and branch cables comprises a high-voltage conductor contained within an inner insulator and a shield between the inner insulator and an outer insulator, the trunk cable having an area that is larger than an area of any of the branch cables.

13. The system of claim 12, wherein the high-voltage conductor, the shield and the inner and outer insulators are coaxially arranged.

14. The system of claim 13, wherein the high-voltage conductor of the trunk cable is continuous with the high-voltage conductor of each of the plurality of branch cables.

15. The system of claim 13, wherein the outer insulator of the trunk cable is continuous with the outer insulator of each of the plurality of branch cables.

16. The system of claim 11, wherein the trunk cable is fixedly orthogonal to each of the plurality of branch cables.

17. The system of claim 16, wherein the trunk cable is continuous with each of the plurality of branch cables.

18. The system of claim 16, wherein a motor inverter is connected to an end of the trunk cable.

19. The system of claim 18, wherein a high-voltage battery is connected to an end of at least one of the plurality of branch cables to supply the electrical power.

20. The system of claim 11, wherein each of the trunk and branch cables is configured to transmit high-voltage electrical power that is above 60 volts.
